(19) United States
(12) Patent Application Publication
(10) Pub. No.: US 2021/0079911 A1
(43) Pub. Date: Mar. 18, 2021

(54) UNIBODY SHIFT ROD PLUNGER

(71) Applicant: Flowco Production Solutions, LLC, Fort Worth, TX (US)

(72) Inventors: Mitchell A. Boyd, Haslet, TX (US); Garrett S. Boyd, Granbury, TX (US)

(21) Appl. No.: 17/025,322

(22) Filed: Sep. 18, 2020

Related U.S. Application Data
(60) Provisional application No. 62/902,066, filed on Sep. 18, 2019.

(51) Int. Cl. F04B 47/12; E21B 43/12

(52) U.S. Cl. CPC F04B 47/12; E21B 43/121

(57) ABSTRACT

A disclosed unibody bypass plunger has a unitary one-piece hollow body, a valve cage, a clutch system, crimple fastening structures, and a valve. The clutch system is provided in a bottom end of the plunger and is configured to limit a position of the valve. A top end includes an external fish neck with ports or slots. The plunger further includes an integral shift rod that extends out of the top end in a closed configuration and extends out of the bottom end in an open configuration, eliminating a need for a separator rod in a lubricator cap to open and close the valve. Ports or slots may be pluggable with one or more plugs. As such, a fall speed of the plunger may be adjusted based on a number of plugs that are installed, with the greatest fall speed being obtained with all ports or slots unplugged.

### CROSS REFERENCE TO RELATED APPLICATIONS

This application claims the benefit under 35 U.S.C. § 119(e) of U.S. Provisional Patent Application No. 62/902,066 filed on Sep. 18, 2019 and titled UNIBODY SHIFT ROD PLUNGER, which is incorporated, in its entirety, by this reference.

### BRIEF DESCRIPTION OF THE DRAWINGS

The accompanying drawings form a part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein.

FIG. 1 illustrates an oil and gas well fitted with a plunger lift system that is configured to control production, according to an embodiment of the disclosure.

FIG. 2A illustrates a three-dimensional perspective view of a unibody bypass plunger in a closed configuration, according to an embodiment of the disclosure.

FIG. 2B illustrates a three-dimensional perspective view of a unibody bypass plunger in an open configuration, according to an embodiment of the disclosure.

FIG. 3A illustrates a side view of the unibody bypass plunger of FIG. 2A, according to an embodiment of the disclosure.

FIG. 3B illustrates a cross-sectional view of the unibody bypass plunger of FIG. 3A, according to an embodiment of the disclosure.

FIG. 4A illustrates a side view of the unibody bypass plunger of FIG. 2B, according to an embodiment of the disclosure.

FIG. 4B illustrates a cross-sectional view of the unibody bypass plunger of FIG. 4A, according to an embodiment of the disclosure.

### DETAILED DESCRIPTION

This disclosure generally relates to plunger assemblies and gas lift devices that travel through oil, gas, and/or other fluids within well tubing to rejuvenate liquid loading or non-productive wells, and to improvements in the design and construction of components of such gas lift devices.

A newly drilled and completed well typically has sufficient pressure or producing rate within the formation to cause liquids to flow from the formation to the surface without external assistance. Over time, the well's production volume and bottom-hole pressure may decline. When the well pressure or producing rate is no longer sufficient to cause the liquids to flow to the surface, “liquid loading” or a “loaded well” condition may occur. Liquid accumulation in the downhole tubing creates a hydrostatic head that may exceed the well's natural pressure and may cause production to decrease or cease altogether.

For wells that have excess liquids and/or insufficient pressure, it is often desirable to use a plunger lift system as an artificial lifting device that utilizes natural gas energy to unload the liquids after natural well pressures have diminished. These systems may also be known as gas lift plungers, differential pressure operated pistons, bypass plungers, auto-cycling plungers, among other suitable and interchangeable names. A plunger lift system usually requires little to no external energy and is designed to create enough seal around the plunger to efficiently “unload” or lift the liquids to the surface using residual pressure in the well. Accordingly, plunger lift systems may be a cost-effective solution to extend the life of the well.

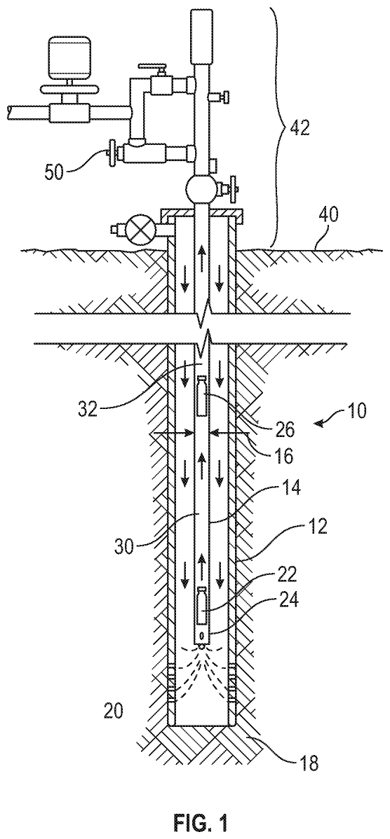

FIG. 1 illustrates an oil and gas well fitted with a plunger lift system for controlling production, according to some embodiments of the disclosure. In this example, a well 10 is formed by a casing 12 that lines the well 10. A tubing string 14, within casing 12, encloses a well bore 16 through which oil or gas 30 is produced from a formation 18 through perforations 20 in the formation 18. The well 10 includes wellhead apparatus 42 disposed on the surface of the earth 40. Wellhead apparatus 42 is configured to direct production of the well to appropriate receptacles or pipelines (not shown) and to control the plunger lift system, as described in greater detail below. Wellhead apparatus 42 may further include one or more valves 50 that may be configured to allow pressurized gas to be injected into the casing to augment the well's natural pressure.

The plunger lift system includes a plunger or bypass plunger 26 that may be introduced into tubing string 14 and allowed to fall through gas and liquid in tubing string 14. Plunger 26 is stopped by a bumper spring assembly 22 at the bottom of tubing string 14. In this example, bumper spring assembly 22 is configured to rest on a seating nipple 24 (which may also be called a tubing or collar stop). As described in greater detail below, plunger 26 has a valve that may be opened to allow gas and fluids to flow through plunger 26 during descent of plunger 26. Upon hitting bumper spring assembly 22, the valve may be closed so that plunger 26 forms a seal between gas/liquids above and below plunger 26. The natural gas energy in well bore 16 then pushes plunger 26 upward. As such, plunger 26 pushes or lifts a “slug” of fluid 32 ahead of plunger 26. Plunger 26 thereby acts to clear the liquid load from the well as plunger 26 is forced upward by natural gas energy below.

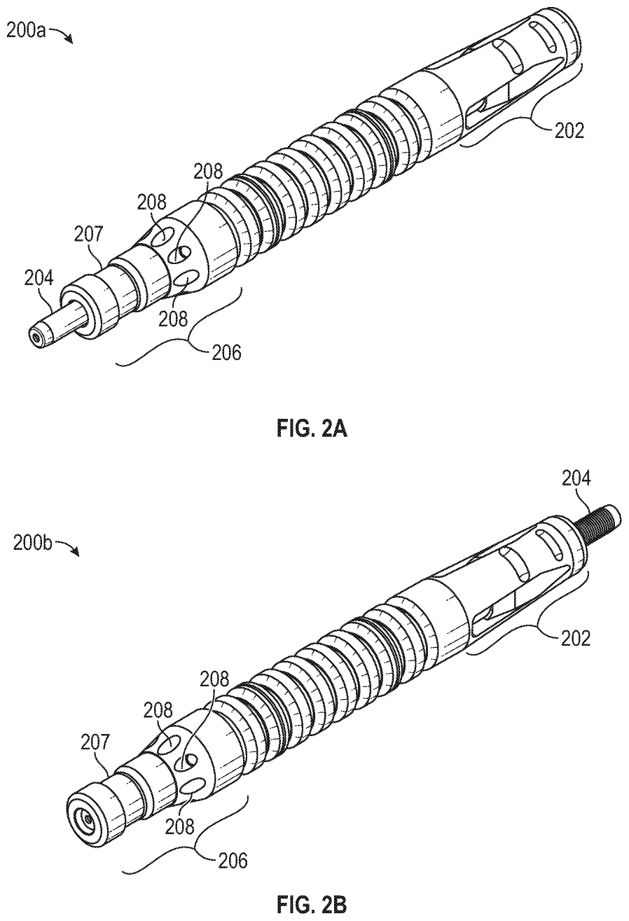

FIGS. 2A and 2B illustrate three-dimensional perspective views of a unibody bypass plunger in a closed configuration 200a and in an open configuration 200b, respectively, according to an embodiment of the disclosure. The unibody bypass plunger of FIGS. 2A and 2B has a unitary or one-piece hollow body-and-valve cage design, a clutch system, crimple fastening structures, and dart and clutch profile that is similar to bypass plungers described, for example, in U.S. Pat. Nos. 9,951,591; 9,963,957; and 10,273,789; the disclosure of each of which is incorporated by reference herein. The terms “one-piece,” “unitary,” “unibody,” “monolithic,” and “single-piece” are used interchangeably herein and refer to a structure that is formed of a single piece of material. The single piece of material may be formed, shaped, additively manufactured, machined, cast, molded, or formed through some other suitable process to provide a unibody structure.

The clutch system is provided in a bottom end 202 of the unibody bypass plunger, as described in the above-cited patents. In contrast to previous designs, however, the unibody bypass plunger of FIGS. 2A and 2B includes an integral shift rod 204. In many cases, the shift rod 204 is formed as a single-piece and extends out of the top 206 of the plunger body in a closed configuration as shown, in FIG. 2A, and extends out of the bottom 202 of the plunger body in an open configuration as shown, in FIG. 2B. In this regard, the unibody bypass plunger does not require a separator rod in a lubricator cap to open and close the valve.

A top 206 of the unibody bypass plunger provides a further contrast from previous designs. In this regard, the top 206 includes an external fish neck 207 with ports or slots 208 instead of an internal fish neck. Ports or slots 208 are configured to be pluggable with one or more plugs, as described in greater detail in U.S. patent application Ser. No. 16/294,660, the disclosure of which is incorporated by reference herein. The term “ports or slots” refers to an opening that provides a passageway through the wall of the device. In many instances, the terms ports or slots are used interchangeably. A fall speed of the unibody bypass plunger may be adjusted based on a number of plugs that are installed, with the greatest fall speed being obtained with all ports 208 unplugged.

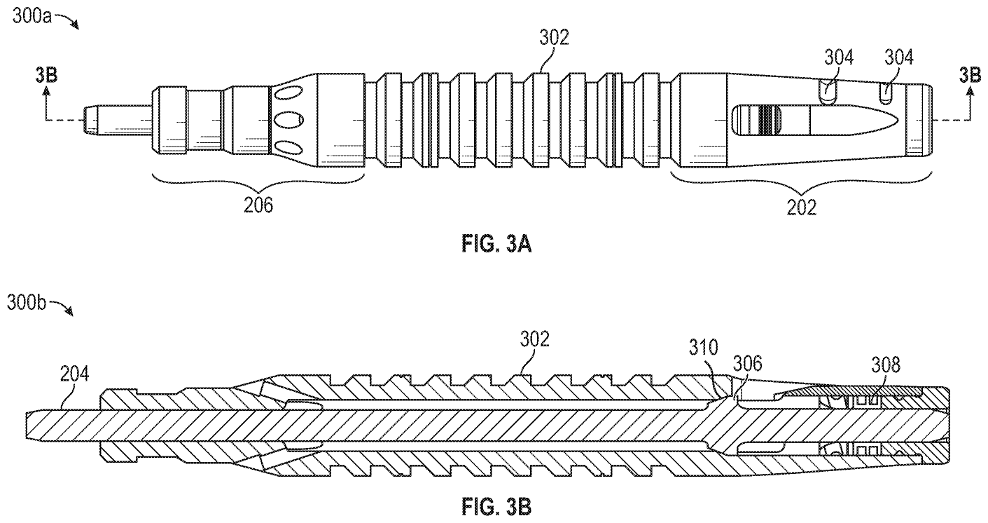

FIG. 3A illustrates a side view 300a of the unibody bypass plunger of FIG. 2A, according to some embodiments of the disclosure. The unibody bypass plunger includes the unitary or one-piece hollow body 302, as described in greater detail in the above-cited patents. The clutch system and valve dart are held in place using crimple features 304 as shown in FIG. 3B and described in greater detail in the above-cited patents. FIG. 3A also defines a cross section direction 3B-3B defining the cross-sectional view of FIG. 3B.

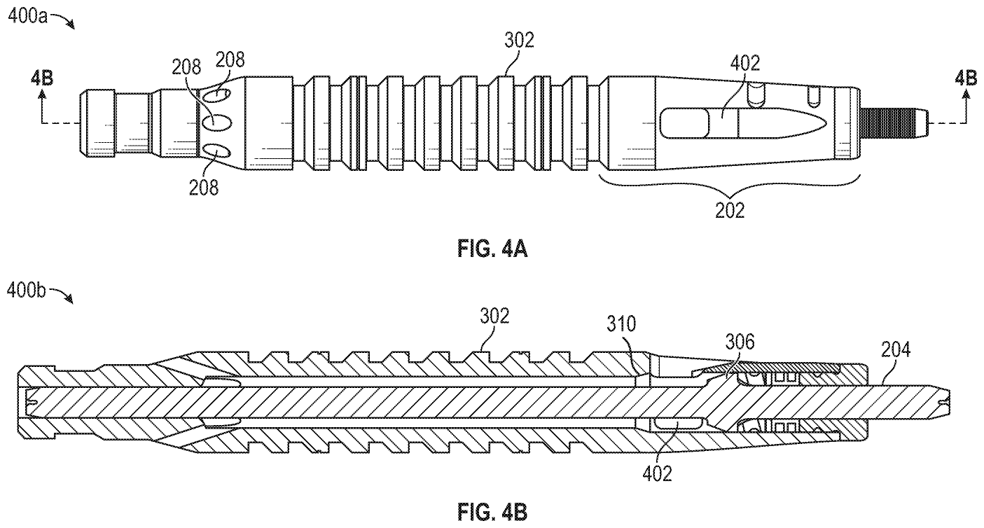

FIG. 3B illustrates a cross-sectional view 300b of the unibody bypass plunger of FIG. 3A, according to an embodiment of the disclosure. The view 300b of FIG. 3B is defined by the cross section direction 3B-3B shown in FIG. 3A. As shown, the shift rod 204 is an integral component of the unibody bypass plunger and extends along a length of the plunger body 302. The shift rod may be formed as a single piece (e.g., unibody construction). Further, the shift rod 204 is configured to be longer than the length of the plunger body to thereby extend for a certain distance outside of the plunger body. The shift rod 204 extends out of the top 206 of the plunger body in a closed configuration as shown, for example, in FIGS. 2A 3A, and 3B, and extends out of the bottom 202 of the plunger body in an open configuration as shown, for example, in FIGS. 2B, 4A, and 4B. Shift rod 204 may be configured to include flats or other features (not shown) to provide an increased bypass flow area. Shift rod 204 may further include a step up (not shown) to increase rod size behind the port break though area in an inner diameter of the plunger body to increase rod rigidity. The clutch system 308 is configured to hold the shift rod 204 in the open or closed position, as described in greater detail in U.S. Pat. No. 9,963,957 (cited above). In this view 300b, a valve 306 is in a closed configuration, in which the valve 306 seals against a valve seat 310 formed within the plunger body 302. The valve 306 is moved between an open configuration and the closed configuration by actuation of the shift rod 204 as it translates axially within the plunger body 302. In some cases, the shift rod 204 translates axially automatically as it reaches the bottom of the drill string and the top of the drill string.

In some cases, the valve seat is formed within a boundary zone near the bottom end 202. The boundary zone may include the internal valve seat 310 conformably shaped to a profile of the valve 306 portion of the shift rod plunger. The valve seat 310 has a portion that is angled relative to a longitudinal axis of the bypass plunger. The valve seat 310 may be formed in the bottom end 202 of the bypass plunger at a location that has a constant outside diameter.

According to some embodiments, the boundary zone has a uniform diameter defining a first diameter and an outside diameter of the bottom end is tapered with a uniform taper angle from a first end of the monolithic one-piece tubular plunger unit to the first diameter of the boundary zone.

FIGS. 4A and 4B illustrate similar views of the unibody bypass plunger as shown in FIGS. 3A and 3B. In this regard, FIG. 4A illustrates a side view 400a and FIG. 4B illustrates a cross sectional view 400b of the unibody bypass plunger in an open configuration. The cross-sectional view of FIG. 4B is defined by the cross-sectional direction 4B-4B shown in FIG. 4A. In this configuration, shift rod 204 is shown extending out of the bottom 202 of the unibody bypass plunger. As shown, in this configuration, valve 306 is in an open configuration, that is, the valve 306 is moved away from the valve seat 310 to allow fluid to flow through the plunger body 302. During operation, the open configuration of valve 306 allows fluids to flow through ports 208 and slots 402, as shown in FIG. 4B, and flow through the plunger body 302. In further embodiments, greater or fewer slots 402 may be provided. Alternatively, slots 402 may be replaced with ports or other apertures, such as ports 208 provided in the top 206 of the unibody bypass plunger. Similarly, ports 208 may be replaced with slots or other types of apertures

The external texture of body 302 is configured as a turbulent seal style. In further embodiments, the external texture may be padded, diamond cut, rifled, or even be a brush style plunger. Such alternate textures are described in greater detail in U.S. patent application Ser. No. 16/361,651, and in U.S. Provisional Patent Application Nos. 62/876,155 and 62/773,749, the disclosure of each of which is incorporated by reference herein.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

While this disclosure is described with reference to various embodiments, it is noted that such embodiments are illustrative and that the scope of the disclosure is not limited to them. Those of ordinary skill in the art may recognize that many further combinations and permutations of the disclosed features are possible. As such, various modifications may be made to the disclosure without departing from the scope or spirit thereof. In addition or in the alternative, other embodiments of the disclosure may be apparent from consideration of the specification and annexed drawings, and practice of the disclosure as presented herein. The examples put forward in the specification and annexed drawings are illustrative and not restrictive. Although specific terms are employed herein, they are used in a generic and descriptive sense only and not for purposes of limitation.

What is claimed is:

1. A plunger for a plunger-lift apparatus, the plunger comprising:
a monolithic hollow plunger body; and
a one-piece shift rod within the plunger body, the shift rod including a valve.

2. The plunger of claim 1, further comprising:
a bottom end having a clutch assembly that is configured to limit a position of the valve.

3. The plunger of claim 1, further comprising:
a valve cage having one or more flow ports formed as passages through a cylindrical wall of the valve cage.

4. The plunger of claim 1, further comprising a top end having an external fish neck having one or more ports.

5. The plunger of claim 4, wherein the one or more ports of the external fish neck are configured to be closed by plugs to control a flow of fluids through the ports.

6. The plunger of claim 1, wherein the monolithic hollow plunger body further comprises a valve seat.

7. The plunger of claim 6, wherein the valve seals against the valve seat when the one-piece shift rod is in a closed configuration.

8. The plunger of claim 7, wherein the one-piece shift rod is configured to move from the closed configuration to an open configuration in which the valve moves away from the valve seat.

9. The plunger of claim 1, wherein the one-piece shift rod and valve is a monolithic structure.

10. The plunger of claim 1, further comprising a crimple fastening structure formed in the monolithic hollow plunger body.

11. The plunger of claim 10, wherein the crimple fastening structure secures a clutch within the monolithic hollow plunger body.

12. The plunger of claim 1, further comprising one or more plugs configured to close off one or more flow ports in a valve cage of the monolithic hollow plunger body.

13. A plunger lift apparatus, comprising:
a one-piece hollow plunger body having a first end, a second end, and a first length therebetween, a valve cage adjacent the first end, the valve cage having one or more flow ports formed to create a fluid passageway from a first location outside the hollow plunger body to a second location inside the hollow plunger body, the hollow plunger body further comprising a valve seat; and
a single-piece shift rod located within the hollow plunger body and having a valve configured to engage with the valve seat, wherein the shift rod has a second length that is greater than the first length.

14. The plunger lift apparatus of claim 13, wherein the shift rod is moveable between a first configuration in which the valve is sealed against the valve seat and a second configuration in which the valve is spaced apart from the valve seat.

15. The plunger lift apparatus of claim 14, wherein the shift rods extends beyond the first end of the hollow plunger body when in the first configuration, and extends beyond the second end of the hollow plunger body when in the second configuration.

16. The plunger lift apparatus of claim 15, further comprising a bumper spring assembly at a bottom of a tubing string, the bumper spring assembly configured to translate the shift rod between the second configuration and the first configuration when the hollow plunger body contacts the bumper spring assembly.

17. The plunger lift apparatus of claim 15, further comprising one or more apertures creating a fluid pathway between a first location outside the hollow plunger body and a second location inside the hollow plunger body.

18. The plunger lift apparatus of claim 17, further comprising a plug configured to selectively seal individual ones of the one or more apertures.

19. The plunger lift apparatus of claim 13, further comprising an external fish neck formed in the hollow plunger body.

20. The plunger lift apparatus of claim 13, wherein the shift rod is configured to automatically translate axially in a first direction when the hollow plunger body reaches a bottom of a drill string, and is further configured to automatically translate axially in a second direction when the plunger lift apparatus reaches a top of the drill string.
